(19) United States
(12) Patent Application Publication
(10) Pub. No.: US 2008/0094012 A1
(43) Pub. Date: Apr. 24, 2008

(54) Position feedback device for linear motor

(75) Inventors: Lieh-Feng Huang, Taichung (TW); Fang-Fang Tai, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/582,909

(22) Filed: Oct. 18, 2006

(51) Int. Cl. H02P 7/00

(52) U.S. Cl. 318/135

(57) ABSTRACT

A position feedback device for a linear motor utilizes Hall sensors which are properly positioned to induct the magnetic field variation of a linear motor and processing the inducted information with the OP amplifiers and signal level regulators to output Sine and Cosine differential signals.

### BACKGROUND OF THE INVENTION

1. Technical Field

The present invention is related to a linear motor, and more particularly to a device that inducts the variation of the magnetic field during the move of a linear motor with Hall sensors and generates position feedback signals to facilitate servo control.

2. Description of Related Art

Optical sensing is known to be used for control of linear motors and generally materialized as a magnetic scale system which comprises an optical sensor, an optical ruler made of glass and having scales as well as a magnetic sensor. An encoder and an illuminant of the magnetic scale system are moving synchronously with the moving object so that the light generated by the illuminant diffracts when permeating the optical ruler and the displacement of the object can be derived by calculating the number of the diffraction fringes. To achieve high-definition magnetic scale system that performs precise control of a linear motor, the optical ruler must be made under accurate production with physical-parameter-considered material. Thus, the high performance of the magnetic scale system signifies high equipment costs.

Therefore, said magnetic scale system may lack for industrial competitiveness and economical advantage in the case that only relative lower reproducibility is demanded.

### SUMMARY OF THE INVENTION

The present invention has been accomplished under the circumstances in view.

It is one object of the present invention to provide a position feedback device, which eliminates the need of an expansive optical ruler as described above by using Hall sensors to induct the variation of the magnetic field generated by stator in a linear motor with the Hall sensors and generates position feedback signals to facilitate servo control.

It is another object of the present invention to provide a position feedback device, which replaces the conventional magnetic scale system and in turn saves the time and energy for installing the magnetic sensor thereof.

It is still another object of the present invention to provide a position feedback device, which efficiently eliminates potential signal bias and environmental interference by implementing OP amplifiers and difference amplifiers.

It is yet another object of the present invention to provide a position feedback device, which is capable of adjusting the output swing and signal levels to eliminate the effect of the magnetic field.

The technical measures taken by the invention to achieve foregoing purpose and effect are given below.

A position feedback device for a linear motor primarily comprises:

a set of Hall sensors which are deposited at the positions corresponding to 0 degree and 90 degrees of the feedback sinusoidal signal of magnetic field of a motor stator respectively;

a set of OP amplifiers;

a set of signal level regulators; and

a set of difference amplifiers.

The disclosed device implements a pair of Hall sensors to induct the mechanical vibration of the stator of a moving motor and processes the vibration with OP amplifiers and signal level regulators to output Sine and Cosine differential signals.

### BRIEF DESCRIPTION OF THE DRAWINGS

FIG. 1 is a schematic drawing illustrating the positions of the Hall sensors according to the present invention;

FIG. 2 is a schematic drawing showing the circuit layout of the disclosed device with a linear motor;

FIG. 3 is an exploded view of the position feedback device of the present invention;

FIG. 4 is a perspective view of the position feedback device of the present invention;

FIG. 5 is a schematic drawing showing the position feedback device of the present invention assembled with a linear motor;

### DETAILED DESCRIPTION OF THE PREFERRED EMBODIMENT

A linear motor produces a linear force along its length under the effect of magnetic fields. The present invention, whereupon, utilizes sensing components to induct the variation of the magnetic field of an operating linear motor and processes the inducted information into sinusoidal signal as position feedback information.

The basic physical principle underlying the Hall effect is that when a carrier of a solid material move in a plied external magnetic field, it deflects under the Lorentz force and a charge imbalance therefore develops between opposite sides of the material to form an electric field perpendicular to the electric current. When the Lorentz force acting on the carrier is eventually balanced by the repulsion of the electric field, a stable potential difference is therefore established between opposite sides of the material.

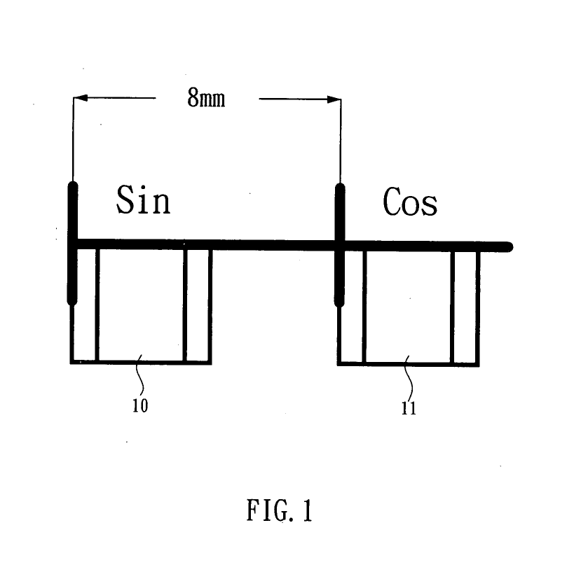

In one embodiment of the present invention, referring to FIG. 1, a pair of Hall sensors 10, 11 are arranged at the positions respectively corresponding to the onset point and quarter point of the pole pitch of a linear motor for inducting the magnetic field shift between N and S poles thereof and produce sinusoidal signals which are finally transformed into Sine and Cosine signals that can be referred as position feedback information. Since the single difference between Sine signals and Cosine signals is at 90 degrees what is equal to a quarter of 360 degrees, in FIG. 1, as the pole pitch of a linear motor is, for instance, 32 mm, the distance between points for collecting Sine and Cosine signals should be a quarter of 32 mm, namely 8 mm. Therefore, as the position of Sine Hall sensor 10 is taken as a datum point, the Cosine Hall sensor 11 should be arranged with 8 mm distant therefrom.

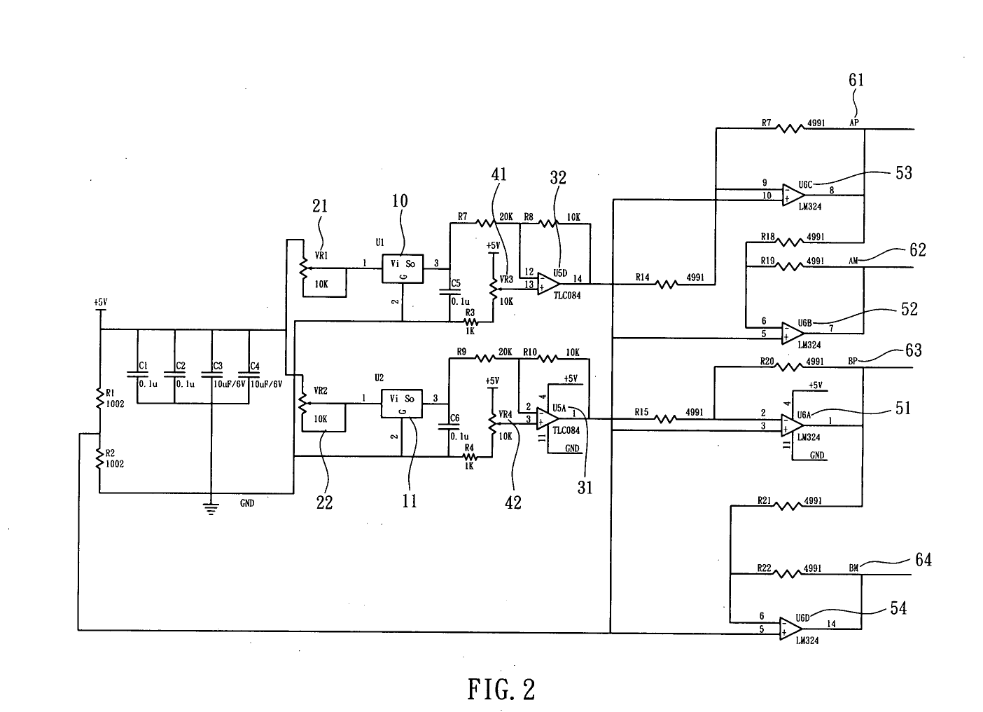

FIG. 2 illustrates an exemplificative circuit layout according to the present invention, wherein U1 and U2 represent respectively a Sine Hall sensor 10 and Cosine Hall sensor 11 for inducting the magnetic fields of a linear motor and producing sinusoidal signals; VR 1 and VR 2 represent variable resistances 21, 22 for adjusting voltage and current input from U1 and U2 and regulating output swing 10, 12; U5A and U5D represent signal amplifiers 31, 32; VR3 and VR4 symbolize signal level regulators 41, 42; U6A to U6D symbolize differential amplifiers 51, 52, 53, 54 which outputs signal 1Vp-p; AP 61 and AM 62 symbolize Sine sinusoidal signals and BP 63 and BM 64 symbolize Cosine sinusoidal signals.

Said differential amplifiers 51, 52, 53, 54 are provided for eliminating environmental interference and said OP amplifiers 31, 32 are provided for eliminating signal bias.

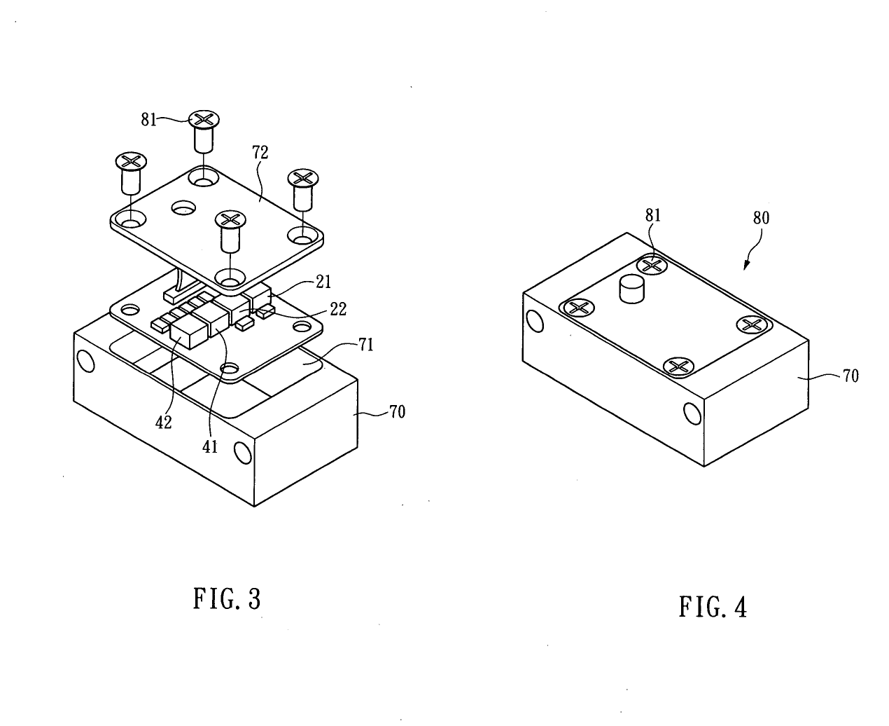

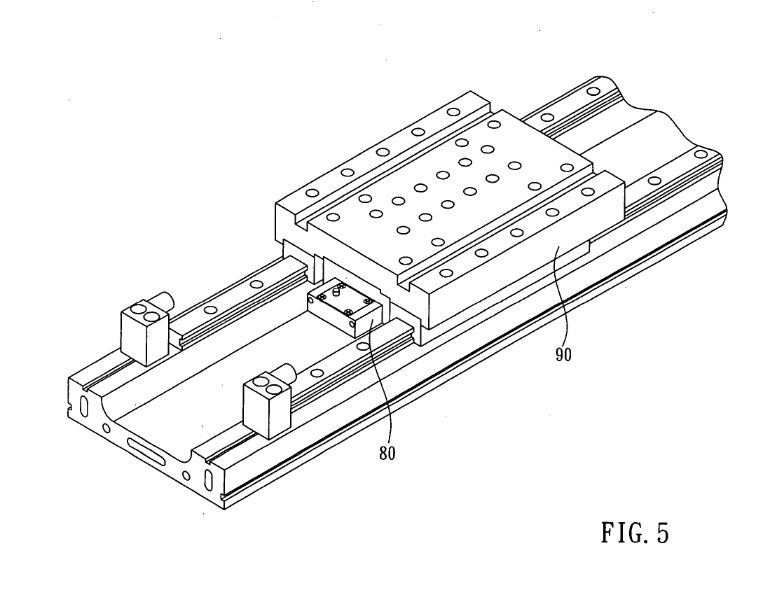

FIGS. 3 and 4 are showing the fabrication of the disclosed device. Said circuit is installed in a case 70 with a depression 71. Then a cover 72 is mounted on the case 70 and to be further fastened with the case 70 by a plurality of fasteners 81 so that the position feedback device 80 of the present is accomplished. Furthermore, FIG. 5 describes the position feedback device 80 of the present invention applied to a linear motor 90. Before the position feedback device 80 is implemented, the signal level regulators VR3 and VR4, indicated as numerals 41, 42 are to be calibrated for performing output signals as level 0 and then the linear motor 90 is shifted for calibrating the output signals as 1Vp-p.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

What is claimed is:

1. A position feedback device for a linear motor primarily comprising:
a set of Hall sensors,
a set of OP amplifiers,
a set of signal level regulators, and
a set of difference amplifiers to transform the magnetic field variation into position feedback signals that facilitates servo control.

2. The position feedback device as claimed in claim 1, wherein the Hall sensors are respectively positioned at the positions corresponding to 0 degree (Sine) and 90 degrees (Cosine) of the feedback sinusoidal signal of magnetic field of a motor stator.

3. The position feedback device as claimed in claim 1, wherein the Hall sensors are respectively positioned at the positions corresponding to a datum point and a quarter point of a pole pitch of a linear motor.

4. The position feedback device as claimed in claim 1, wherein the output signals comprise Sine sinusoidal signals and Cosine sinusoidal signals.

5. The position feedback device as claimed in claim 1, wherein the output signals comprise differential signals.
